(19) United States
(12) Patent Application Publication
(10) Pub. No.: US 2025/0136445 A1
(43) Pub. Date: May 1, 2025

(54) HYDROGEN PEROXIDE MANUFACTURING PROCESS AND MANUFACTURING SYSTEM BASED ON PHOTOCHEMICAL REACTION

(71) Applicant: KOREA INSTITUTE OF SCIENCE AND TECHNOLOGY, SEOUL (KR)

(72) Inventors: Jee Hye BYUN, Seoul (KR); Dong Ki LEE, Seoul (KR); Chanhee BOO, Seoul (KR)

(21) Appl. No.: 18/427,570

(22) Filed: Jan. 30, 2024

(30) Foreign Application Priority Data
Oct. 26, 2023 (KR) 10-2023-0144775

(51) Int. Cl. C01B 15/026; B01J 31/06; B01J 31/40; B01J 35/39; C01B 15/013

(52) U.S. Cl. CPC C01B 15/026; B01J 31/06; B01J 31/4007; B01J 35/39; C01B 15/013

(57) ABSTRACT

The present invention relates to hydrogen peroxide manufacturing process and manufacturing system based on a photochemical reaction. Specifically, the present invention relates to a series of hydrogen peroxide manufacturing processes of generating, extracting, and purifying hydrogen peroxide through a photochemical reaction, and a hydrogen peroxide manufacturing system which is applied with the manufacturing processes and consists of a photoreactor-extractor-purifier.

### CROSS-REFERENCE TO RELATED APPLICATION

This application claims priority to and the benefit of Korean Patent Application No. 10-2023-0144775 filed in the Korean Intellectual Property Office on Oct. 26, 2023, the entire contents of which are incorporated herein by reference.

### BACKGROUND OF THE INVENTION

### (a) Field of the Invention

The present invention relates to a hydrogen peroxide manufacturing process and manufacturing system based on a photochemical reaction. Specifically, the present invention relates to a series of hydrogen peroxide manufacturing processes of generating, extracting, and purifying hydrogen peroxide through a photochemical reaction, and a hydrogen peroxide manufacturing system which is applied with the manufacturing processes and consists of a photoreactor-extractor-purifier.

### (b) Description of the Related Art

When hydrogen peroxide is industrially produced, at least 90% of total fruit tree production is accomplished through an anthraquinone oxidation/reduction process. The anthraquinone oxidation/reduction process is a method of generating hydrogen peroxide by reducing oxygen molecules within a repetitive oxidation/reduction cycle of anthraquinone molecules. The process is performed under reaction conditions of high temperature of 50° C. or higher and high pressure of 4 bar or more, so that a large amount of energy and high costs are required. In addition, the use of rare metal catalysts such as palladium (Pd) in the process may also be a cause in increasing required cost. In particular, rare metals used as catalysts may not be easily obtained due to high dependence on resource imports.

The anthraquinone oxidation/reduction process causes problems not only from an economic aspect, but also from an environmental aspect. Through the high-temperature and high-pressure process, a large amount of carbons is generated, and toxic reaction by-products due to the use of metal catalysts are generated to cause environmental problems. In addition, since hydrogen (H₂) gas is used in the process, there is a problem that there is a risk of explosion.

In addition to the problem to be scattered in the process itself, there is increasing a need for eco-friendly low-carbon hydrogen peroxide production technology that is effective in industrial sites. Actually, a relatively low concentration (less than 2 wt %) of hydrogen peroxide is used in water treatment plants and semiconductor cleaning processes, which are large consumers of hydrogen peroxide, so that the effectiveness of technology of producing hydrogen peroxide in a distributed manner on sites may be high. Currently, there are electrochemical technology and photocatalyst technology as eco-friendly technology for producing hydrogen peroxide, but there are clear limitations in performance, production scale, purification costs, etc., thereby making practical use difficult.

The hydrogen peroxide production technology that is usable in industrial sites is to produce hydrogen peroxide in an eco-friendly and low-carbon manner, but production technology with high safety while satisfying the production scale of hydrogen peroxide required in actual industry is required.

### SUMMARY OF THE INVENTION

The present disclosure attempts to provide a hydrogen peroxide manufacturing process capable of producing hydrogen peroxide with high efficiency using a photochemical reaction.

The present disclosure also attempts to provide a hydrogen peroxide manufacturing system capable of applying the hydrogen peroxide manufacturing process having the aforementioned advantages and consisting of a series of photoreactor-extractor-purifier.

An exemplary embodiment of the present invention provides a hydrogen peroxide manufacturing process including a production step of generating hydrogen peroxide by supplying oxygen and irradiating light to an organic reaction solution, an extraction step of separating the hydrogen peroxide into an aqueous solution by mixing the organic reaction solution in which the hydrogen peroxide is generated and water, and a purification step of filtering the extracted hydrogen peroxide aqueous solution using a reverse osmosis membrane, in which the organic reaction solution includes a hydrophobic organic solvent in the range of 50 volume % or more based on the total volume of the organic reaction solution.

Another exemplary embodiment of the present invention provides a hydrogen peroxide manufacturing system including a reactor capable of producing hydrogen peroxide through a photoautoxidation reaction using an organic reaction solution, an extractor that extracts the hydrogen peroxide produced in the reactor into an aqueous solution using a large amount of water, and a purifier for separating and purifying the hydrogen peroxide in the aqueous solution, in which the reactor, the extractor, and the purifier are sequentially connected to each other, a catalyst regenerator is located between the reactor and the extractor and connected to the reactor through a circulation pipe, a mixer is located between the extractor and the catalyst regenerator to mix the organic reaction solution from which the polymer photocatalyst is separated and water for extraction, and a stirrer is further included in the mixer.

According to the hydrogen peroxide manufacturing process according to an exemplary embodiment of the present invention, it is possible to improve the production efficiency of hydrogen peroxide by a photochemical reaction of an organic reaction solution and to provide a method for obtaining hydrogen peroxide in high purity and high concentration.

According to the hydrogen peroxide manufacturing system according to another exemplary embodiment of the present invention, it is possible to improve the production efficiency of hydrogen peroxide by a photochemical reaction of an organic reaction solution in a photoreactor, and to obtain hydrogen peroxide in high purity and concentration by an extractor and a purifier connected in series to the photoreactor.

### BRIEF DESCRIPTION OF THE DRAWINGS

FIG. 1 is a schematic diagram illustrating a continuous hydrogen peroxide manufacturing system and manufacturing process based on a photochemical reaction according to an exemplary embodiment of the present invention.

FIG. 2 illustrates production and solar-chemical conversion efficiency (SCC efficiency) of hydrogen peroxide and an oxidized organic product, benzaldehyde (BzCHO) according to a 50-hour continuous process of an organic reaction solution included in the hydrogen peroxide manufacturing process and manufacturing system according to an exemplary embodiment of the present invention.

FIG. 3 illustrates purity and concentration of hydrogen peroxide prepared according to an exemplary embodiment of the present invention.

FIG. 4 illustrates water treatment performance for organic pollutants of high-concentration and high-purity hydrogen peroxide prepared according to an exemplary embodiment of the present invention.

### DETAILED DESCRIPTION OF THE EMBODIMENTS

The technical terms used herein is for the purpose of describing specific exemplary embodiments only and are not intended to be limiting of the present invention. The singular forms used herein include plural forms as well, if the phrases do not clearly have the opposite meaning. The “comprising” used in the specification means that a specific feature, region, integer, step, operation, element and/or component is embodied and other specific features, regions, integers, steps, operations, elements, components, and/or groups are not excluded.

Unless defined otherwise, all terms including technical and scientific terms used herein have the same meaning as commonly understood by those skilled in the art to which the present invention belongs.

Hereinafter, exemplary embodiments of the present invention will be described in detail. However, these exemplary embodiments are presented as examples, and the present invention is not limited thereto, and the present invention is only defined by the scope of claims to be described below

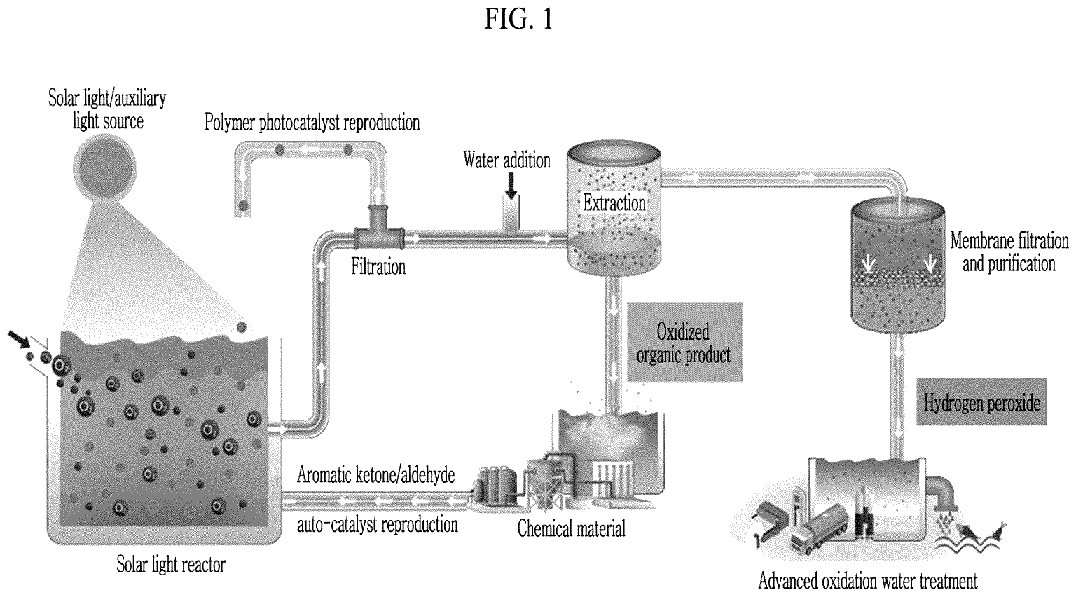

FIG. 1 is a schematic diagram illustrating a continuous hydrogen peroxide manufacturing system and manufacturing process based on a photochemical reaction according to an exemplary embodiment of the present invention.

Referring to FIG. 1, a hydrogen peroxide manufacturing process according to an exemplary embodiment of the present invention may include a production step of generating hydrogen peroxide by supplying oxygen and irradiating light to an organic reaction solution, an extraction step of separating the hydrogen peroxide into an aqueous solution by mixing the organic reaction solution in which the hydrogen peroxide is generated and water, and a purification step of filtering the extracted hydrogen peroxide aqueous solution using a reverse osmosis membrane, wherein the organic reaction solution may include a hydrophobic organic solvent in the range of 50 volume % or more based on the total volume of the organic reaction solution.

In the production step of the hydrogen peroxide manufacturing process according to an exemplary embodiment, the organic reaction solution is a mixture of aromatic alcohol and an organic solvent, and the aromatic alcohol may include 0.1 wt % to 0.2 wt % of an aromatic carbonyl compound based on the total weight of the aromatic alcohol.

Specifically, the aromatic carbonyl compound included in the amount of 0.1 wt % to 0.2 wt % is auto-oxidized and contained in the aromatic alcohol. In addition, the aromatic carbonyl compound containing a portion of the aromatic alcohol oxidized may serve as an auto-catalyst, which is both a catalyst and an oxidation reaction product in the organic reaction solution.

The production step of the hydrogen peroxide manufacturing process according to an exemplary embodiment may include further mixing an aromatic carbonyl compound with the organic reaction solution.

The aromatic carbonyl compound may be added to promote the generation of hydrogen peroxide in the organic reaction solution.

In the production step of the hydrogen peroxide manufacturing process according to an exemplary embodiment, the further mixed aromatic carbonyl compound may include at least one selected from aromatic ketones or aromatic aldehydes.

The aromatic ketones or aromatic aldehydes may include at least one selected from benzaldehyde (BzCHO), 9-anthracenecarboxaldehyde, 9-anthraldehyde, 9-phenanthrenecarboxaldehyde, fluorene-2-carboxaldehyde, 1-pyrenecarboxaldehyde, 1-naphthaldehyde, 2-naphthaldehyde, biphenyl-4-carboxaldehyde, benzophenone, 4-methylbenzaldehyde (p-tolualdehyde), 3-methylbenzaldehyde (m-tolualdehyde), 2-methylbenzaldehyde (o-tolualdehyde), 4-chlorobenzaldehyde, 3-chlorobenzaldehyde, 2-chlorobenzaldehyde, 4-fluorobenzaldehyde, 3-fluorobenzaldehyde, 2-fluorobenzaldehyde, 4-bromobenzaldehyde, 3-bromobenzaldehyde, 2-bromobenzaldehyde, 1-(p-tolyl) ethanone, 1-(4-fluorophenyl) ethanone, p-anisaldehyde, 4-formylbenzonitrile, 4-methoxyacetophenone, 4-acetylbenzonitrile, anthraquinone, fluorenone, acetophenone, xanthone, and thioxanthone.

However, the present invention is not limited to the types of aromatic ketones or aromatic aldehydes described above, and may be extended and applied to materials belonging to aromatic ketones or aromatic aldehydes capable of promoting the generation of hydrogen peroxide in the organic reaction solution in addition to the materials described above.

In the production step of the hydrogen peroxide manufacturing process according to an exemplary embodiment, based on the total volume of the mixture of the aromatic alcohol, the organic solvent, and the further mixed aromatic carbonyl compound, the aromatic carbonyl compound may be further mixed and included in the range of 0.001 volume % to 30 volume %. Preferably, the aromatic carbonyl compound may be included in the range of 0.001 volume % to 20 volume %. More preferably, the aromatic carbonyl compound may be included in the range of 0.001 volume % to 10 volume %. More preferably, the aromatic carbonyl compound may be included in the range of 1 volume % to 10 volume %.

When the mixing amount of the further mixed aromatic carbonyl compound is within the above-mentioned range, there is an advantage in that the light absorption and photoautoxidation reaction of the aromatic carbonyl compound are promoted, thereby improving the hydrogen peroxide productivity. On the other hand, when the mixing amount of the further mixed aromatic carbonyl compound is less than the lower limit of the above-mentioned range, there may be a problem in that the effect of photoautoxidation by aromatic carbonyl is insignificant. When the mixing amount of the further mixed aromatic carbonyl compound is more than the upper limit of the above-mentioned range, aromatic radicals generated during the reaction of the organic reaction solution are homocoupled to produce organic by-products rather than hydrogen peroxide, which may be disadvantageous in terms of hydrogen peroxide production efficiency.

However, even if the aromatic carbonyl compound is not further mixed, a trace amount of aromatic ketones or aromatic aldehydes contained in the aromatic alcohol acts as an auto-catalyst to improve the hydrogen peroxide productivity of the organic reaction solution as the specific gravity of the aromatic alcohol increases.

In the production step of the hydrogen peroxide manufacturing process according to an exemplary embodiment, the aromatic alcohol may include at least one selected from the group consisting of benzyl alcohols substituted with electron-withdrawing and electron-donating functional groups.

The group consisting of benzyl alcohols substituted with electron-withdrawing and electron-donating functional groups may include benzyl alcohol (BzOH), 4-fluorobenzyl alcohol (F-BzOH), 3-fluorobenzyl alcohol, 2-fluorobenzyl alcohol, 4-methylbenzyl alcohol (M-BzOH), 3-methylbenzyl alcohol, 2-methylbenzyl alcohol, α-methylbenzyl alcohol (α-M-BzOH), diphenylmethanol (DPM), and cinnamyl alcohol.

However, the present invention is not limited to the types of aromatic alcohols described above, and may be extended and applied to materials belonging to aromatic alcohols capable of promoting the generation of hydrogen peroxide in the organic reaction solution in addition to the materials described above. In particular, based on a benzyl alcohol structure, the types of aromatic alcohols applicable to the present invention may be extended depending on the types of 2-, 3-substituents, electron-withdrawing substituents, and electron-donating substituents.

In the production step of the hydrogen peroxide manufacturing process according to an exemplary embodiment, the aromatic alcohol may be mixed and included in a volume ratio of 1:99 to 99:1 based on the volume of the organic solvent mixed in the organic reaction solution. Preferably, the volume ratio of the organic solvent and the aromatic alcohol may be 10:90 to 90:10. More preferably, the volume ratio of the organic solvent and the aromatic alcohol may be 30:70 to 90:10. More preferably, the volume ratio of the organic solvent and the aromatic alcohol may be 50:50 to 90:10. More preferably, the volume ratio of the organic solvent and the aromatic alcohol may be 50:50 to 70:30.

When the volume ratio of the organic solvent and the aromatic alcohol is within the above-mentioned range, the productivity of hydrogen peroxide in the organic reaction solution is improved, and optimal production efficiency may be achieved.

In the production step of the hydrogen peroxide manufacturing process according to an exemplary embodiment, the solubility of oxygen in the organic solvent may be 1 mM to 15 mM based on 1 atm.

When the solubility of oxygen in the organic solvent is within the above-mentioned range, the oxygen concentration in the organic reaction solution is high, so that there is an advantage of increasing the activation of oxygen in the photoautoxidation reaction, thereby increasing the production rate of hydrogen peroxide. On the other hand, if the solubility of oxygen in the organic solvent is less than the lower limit of the above-mentioned range, there may be a problem of slowing the hydrogen peroxide production rate. In addition, if the solubility of oxygen in the organic solvent is more than the upper limit of the above-mentioned range, the oxygen gas pressure in the organic reaction solution needs to be increased, so that the amount of energy added to the reaction increases, thereby reducing energy efficiency.

In the production step of the hydrogen peroxide manufacturing process according to an exemplary embodiment, the organic solvent includes a hydrophobic organic solvent, and the hydrophobic organic solvent may have an octanol-water partition coefficient (log P) value of 0 or more, which is represented by the following Equation 1:

[Equation 1] Octanol-water partition coefficient=log P=log ([C_{oct}]/[C_{water}]) (wherein, [C_{oct}] refers to a molar concentration of the organic solvent dissolved in the octanol layer, and [C_{water}] refers to a molar concentration of the organic solvent dissolved in the water layer.)

When the octanol-water partition coefficient satisfies the above-mentioned range, the hydrogen peroxide produced after the hydrogen peroxide production reaction may be extracted with water. On the other hand, when the octanol-water partition coefficient is not included in the above-mentioned range, in the process of extracting the hydrogen peroxide formed in the organic reaction solution with water, there may be a problem in that due to mixing between the organic reaction solution and water, it is difficult to extract hydrogen peroxide, and simultaneously, the purity of the extracted hydrogen peroxide aqueous solution is lowered.

In the production step of the hydrogen peroxide manufacturing process according to an exemplary embodiment, the organic solvent may include at least one selected from trifluorotoluene, acetonitrile, methanol, ethanol, tert-butanol, 1-propanol, 2-propanol, acetone, ethyl acetate, tert-amyl alcohol, 1-butanol, petroleum ether, pentane, cyclohexane, n-hexane, dichloromethane, chloroform, tetrahydrofuran, 1,4-dioxane, toluene, dimethyl sulfoxide (DMSO), dimethylformamide, 1,2-dichloroethane, 1-octanol, benzonitrile, butanone, cyclohexanone, methyl tert-butyl ether, 2-hexanone, butyl acetate, trichloroethylene, xylene, and ethyl benzene.

However, the present invention is not limited to the types of organic solvents described above, and although not mentioned in the types of materials described above, if there are hydrophobic organic solvents that may be mixed with a small amount of water by satisfying the above-mentioned octanol-water partition coefficient range, the of organic solvents may be extended and applied thereto.

In the production step of the hydrogen peroxide manufacturing process according to an exemplary embodiment, the oxygen supply rate in the production step may be in the range of 10 mL/min to 50 mL/min.

When the oxygen supply rate is within the above-mentioned range, there is an advantage in that a sufficient amount of oxygen is supplied to the organic reaction solution to maximize hydrogen peroxide productivity. On the other hand, if the oxygen supply rate is less than the lower limit of the above-mentioned range, there may be a problem in that the hydrogen peroxide production is lowered due to the small amount of oxygen in the reaction solution. In addition, when the oxygen supply rate is more than the upper limit of the above-mentioned range, in the process of charging oxygen to the organic reaction solution, the organic solvent may evaporate and the stability of the reaction may be lowered due to an increase in pressure due to oxygen.

In the production step of the hydrogen peroxide manufacturing process according to an exemplary embodiment, the oxygen supply time may be in the range of 15 min to 60 min.

When the oxygen supply time is within the above-mentioned range, there is an advantage in that a sufficient amount of oxygen is supplied to the organic reaction solution to maximize hydrogen peroxide productivity. On the other hand, when the oxygen supply time is less than the lower limit of the above-mentioned range, there may be a problem in that the hydrogen peroxide production is lowered due to the small amount of oxygen in the reaction solution. In addition, when the oxygen supply time is more than the upper limit of the above-mentioned range, oxygen may be supplied in excess while the oxygen concentration in the reaction solution is saturated, which may be disadvantageous in terms of process operation costs.

In the production step of the hydrogen peroxide manufacturing process according to an exemplary embodiment, the irradiated light wavelength may include a bandwidth of 200 nm to 500 nm. Preferably, the light wavelength may be a bandwidth of 230 nm to 400 nm. A light source having the corresponding light wavelength may be simulated solar light or a short-wavelength lamp. Specifically, the simulated solar light source includes a wavelength range of 200 nm to 1000 nm, and the short-wavelength lamp includes a wavelength range of 200 nm to 400 nm. In addition, the short-wavelength lamp may be an ultraviolet lamp with an average of 352 nm including a UVA region in a wavelength range of 315 nm to 400 nm.

When the light wavelength is within the above-described range, the light wavelength corresponds to a light absorption region of the aromatic alcohol and the aromatic carbonyl compound in the organic reaction solution, and thus, there is an advantage of maximizing the performance of the reaction. On the other hand, when the light wavelength is less than the lower limit of the above-mentioned range, there may be a problem of degradation of organic materials by strong ultraviolet rays beyond the light absorption region of the organic reaction solution. In addition, when the light wavelength is more than the upper limit of the above-mentioned range, the light wavelength is out of the light absorption region of the aromatic alcohol and the aromatic carbonyl compound in the organic reaction solution, and thus, the reaction efficiency rapidly decreases, which may be disadvantageous in terms of hydrogen peroxide production.

In the production step of the hydrogen peroxide manufacturing process according to an exemplary embodiment, the light irradiation time may be in the range of more than 0 and 60 hours or less.

Since the hydrogen peroxide manufacturing process of the present invention is a photochemical reaction-based process, light needs to be irradiated to the organic reaction solution. In the hydrogen peroxide manufacturing process of the present invention, the light irradiation time is preferably provided within the above-mentioned range, but may also be modified and extended to a range exceeding the upper limit of the above-mentioned range, if necessary.

The production step of the hydrogen peroxide manufacturing process according to an exemplary embodiment may include irradiating light with an irradiance of 10 W/m² to 1000 W/m². Specifically, the irradiance may vary depending on the type of light source that irradiates light to the organic reaction solution. When the light is irradiated using simulated solar light, the light may be irradiated with an irradiance of 900 to 1000 W/m². When the light is irradiated using the short-wavelength lamp, the light may be irradiated with an irradiance of 10 W/m² to 100 W/m².

The production step of the hydrogen peroxide manufacturing process according to an exemplary embodiment includes further mixing a polymer photocatalyst and water with the organic reaction solution, wherein the polymer photocatalyst may include at least one selected from CTF-Ph, CTF-Th, CTF-BPh, and graphitic carbon nitride (g-C₃N₄).

In the hydrogen peroxide manufacturing process of the present invention, extension to other types of polymer photocatalysts other than the above-mentioned types may be further included to improve the production efficiency of hydrogen peroxide.

In the production step of the hydrogen peroxide manufacturing process according to an exemplary embodiment, the concentration of the polymer photocatalyst further mixed with the organic reaction solution may be in the range of 0.1 g/L to 4.0 g/L. Specifically, the concentration of the polymer photocatalyst may be in the range of 0.1 g/L to 2.0 g/L. More specifically, the concentration of the polymer photocatalyst may be in the range of 0.1 g/L to 1.0 g/L.

When the concentration of the polymer photocatalyst is within the above-mentioned range, quantum efficiency may be maximized by adding a reaction in which photoelectrons formed in the photocatalyst selectively reduce oxygen molecules to the autoxidation of the organic reaction solution. As a result, it is possible to improve the production of hydrogen peroxide and derive optimal production efficiency. On the other hand, when the concentration of the polymer photocatalyst is not within the above-mentioned range, the production efficiency of hydrogen peroxide may decrease. In particular, when the concentration is more than the upper limit, the production efficiency of hydrogen peroxide may rapidly decrease.

In the production step of the hydrogen peroxide manufacturing process according to an exemplary embodiment, the water may be included in the range of 0 to 30 mol % based on the total amount of aromatic alcohol contained in the organic reaction solution.

When the amount of water in the organic reaction solution into which the photocatalyst is added is within the above-mentioned range, the production efficiency of hydrogen peroxide may be improved because the water hydrogen-bonds with the organic material to be reacted to lower the oxidation potential. On the other hand, if the amount of water is more than the upper limit of the above-mentioned range, photoelectrons formed in the photocatalyst may be used to reduce hydrogen ions generated by degradation of water, thereby reducing the oxygen molecule reduction rate. As the oxygen molecule reduction rate decreases, there may be a problem in that the production and production efficiency of hydrogen peroxide are reduced.

In the hydrogen peroxide manufacturing process according to an exemplary embodiment of the present invention, even in the case of an organic reaction solution that does not contain a photocatalyst, a small amount of water may be further added. In addition, the small amount of water may function to promote the photoautoxidation reaction by hydrogen-bonding with the aromatic alcohol or aromatic carbonyl to be reacted in the photoautoxidation reaction. On the other hand, the small amount of water may function to inhibit the reaction by quenching aromatic radicals generated in the photoautoxidation reaction. When performing a photoautoxidation reaction without the photocatalyst in the organic reaction solution according to an embodiment of the present invention, the further addition of water tended to slightly inhibit the reaction. However, this is only one aspect of an exemplary embodiment, and when some of the conditions of the aromatic alcohol, the organic solvent, and the further mixed aromatic carbonyl compound presented in the present invention are changed and applied, a small amount of water may also derive a result of promoting the photoautoxidation reaction. In other words, the invention contents presented herein may be partially modified and applied to the hydrogen peroxide manufacturing method, but those skilled in the art may select whether to add water to the organic reaction solution by determining whether there is an advantage to the photoautoxidation reaction.

The volume ratio of the water mixed in the extraction step of the hydrogen peroxide manufacturing process according to an exemplary embodiment and the organic reaction solution in which hydrogen peroxide is generated may be 0.1 to 10.

When the volume ratio is within the above-mentioned range, the hydrogen peroxide generated in the organic reaction solution may be efficiently separated into an aqueous solution. On the other hand, when the volume ratio is less than the lower limit of the above-mentioned range, the hydrogen peroxide may not be separated into an aqueous solution and hydrogen peroxide remaining in the organic reaction solution may be generated. In addition, when the volume ratio is more than the upper limit of the above-mentioned range, the amount of water is excessive compared to the organic reaction solution, so that the organic reaction solution is dispersed in water, and thus there may be a problem in that the organic reaction solution may not be easily separated from water.

In the extraction step of the hydrogen peroxide manufacturing process according to an exemplary embodiment, the method further includes mixing and then stirring the organic reaction solution in which hydrogen peroxide is generated and water for extraction, and a stirring speed may be 100 rpm to 1000 rpm.

When the stirring speed is within the above-mentioned range, the organic reaction solution and the water for extraction are physically mixed well, so that extraction may be performed more easily.

In the extraction step of the hydrogen peroxide manufacturing process according to an exemplary embodiment, the time for which the solution mixed with the organic reaction solution in which hydrogen peroxide is generated and the water for extraction remains inside the extractor may be 1 minute to 180 minutes.

When the retention time of the mixed solution is within the above-mentioned range, there may be an advantage in that the hydrogen peroxide generated in the organic reaction solution is sufficient to move into water to have a high extraction amount. On the other hand, when the retention time of the mixed solution is not within the above-mentioned range, there may be a problem in a low extraction amount due to the hydrogen peroxide remaining in the organic reaction solution.

The extraction step of the hydrogen peroxide manufacturing process according to an exemplary embodiment may include separating a hydrogen peroxide aqueous solution layer and an organic solution layer, and a method of discharging the aqueous solution layer and the organic solution layer may include an intermittent method.

The intermittent method refers to a method of repeating at regular intervals a process of introducing the mixed solution of the organic reaction solution and the water into the extractor, remaining for a predetermined period of time, and then discharging the separated layers by opening the valve when the layers are completely separated. However, the present invention is not necessarily limited to the intermittent method, and may further include modification and extension to a continuous method (a method of continuously discharging the separated layers at a low flow rate while the valve is opened) as necessary.

In the extraction step of the hydrogen peroxide manufacturing process according to an exemplary embodiment, the discharge rate of the aqueous solution layer may be 0.1 L/h to 20 L/h, and the discharge rate of the organic solution layer may be 0.1 L/h to 20 L/h.

When the discharge rate of the aqueous solution layer and the discharge rate of the organic solution layer are within the above-described range, the hydrogen peroxide aqueous solution layer and the organic solution layer may be easily separated from each other while being not mixed with each other. On the other hand, when the discharge rate of the aqueous solution layer and the discharge rate of the organic solution layer are not within the above-mentioned range, there may be a problem in that the hydrogen peroxide extraction efficiency is reduced or the interface separation between the two solution layers is not properly achieved. In the hydrogen peroxide extraction process of the present invention, the discharge rates of the aqueous solution layer and the organic solution layer are preferably provided within the above-mentioned range, but may also include modification and extension to a range exceeding the upper limit of the above-mentioned range depending on a capacity of the reactor.

In the purification step of the hydrogen peroxide manufacturing process according to an exemplary embodiment, a reverse osmosis filtration is operated in a crossflow manner, and based on a reverse osmosis membrane with an effective area of 20 cm², the reverse osmosis filtration speed is 0.05 m/s to 1.0 m/s, and the reverse osmosis membrane is a polyamide reverse osmosis membrane and may have a maximum operating pressure of 80 bar. Specifically, the reverse osmosis filtration speed may be 0.1 m/s to 0.9 m/s. More specifically, the reverse osmosis filtration speed may be 0.15 m/s to 0.7 m/s.

The mass ratio of total organic carbon (TOC) contained in the hydrogen peroxide aqueous solution finally obtained through the hydrogen peroxide manufacturing process according to an exemplary embodiment may be 0.01% to 1% based on the total mass of the hydrogen peroxide aqueous solution. Specifically, the mass ratio of the TOC may be 0.01% to 0.1%.

When the mass ratio of total organic carbon (TOC) to the total mass of the hydrogen peroxide aqueous solution is within the above-mentioned range, the purity of the obtained hydrogen peroxide is high, so that there may be an advantage of being directly applicable to hydrogen peroxide sites where ultra-high purity is required. On the other hand, when the mass ratio of total organic carbon (TOC) to the total mass of the hydrogen peroxide aqueous solution is more than the upper limit, the purity of the produced hydrogen peroxide may be low and its use may be limited only to industrial purposes.

After the production step of the hydrogen peroxide manufacturing process according to an exemplary embodiment, the method may further include a catalyst regeneration step in which the polymer photocatalyst is separated from the organic reaction solution containing hydrogen peroxide discharged from the reactor, supplied in circulation to the reactor, and the organic reaction solution containing hydrogen peroxide from which the catalyst was separated is supplied to the extractor.

FIG. 1 is a schematic diagram illustrating a continuous hydrogen peroxide manufacturing system and manufacturing process based on a photochemical reaction according to an exemplary embodiment of the present invention.

Referring to FIG. 1, a hydrogen peroxide manufacturing system according to another exemplary embodiment of the present invention is a hydrogen peroxide manufacturing system capable of performing the hydrogen peroxide manufacturing process according to the above-described exemplary embodiment, and may include a reactor capable of producing hydrogen peroxide through a photoautoxidation reaction using an organic reaction solution, an extractor that extracts the hydrogen peroxide produced in the reactor into an aqueous solution using a large amount of water, and a purifier for separating and purifying the hydrogen peroxide in the aqueous solution. The reactor, the extractor, and the purifier may be sequentially connected to each other. Further, the hydrogen peroxide manufacturing system may include a catalyst regenerator that is located between the reactor and the extractor and connected to the reactor through a circulation pipe, and a mixer that is located between the extractor and the catalyst regenerator to mix the organic reaction solution from which the polymer photocatalyst is separated and water for extraction, and a stirrer may be further included in the mixer.

In the hydrogen peroxide manufacturing system according to another exemplary embodiment, the reactor may include a reaction tank having at least one reaction solution outlet at the bottom, an inlet capable of injecting an organic reaction solution and oxygen into the reaction tank, an irradiator capable of transmitting light while sealing the reaction tank, and a light source.

In the hydrogen peroxide manufacturing system according to another exemplary embodiment, the extractor may include a solution inlet, a first separator for extracting the hydrogen peroxide aqueous solution, and a second separator for discharging the organic reaction solution from which the hydrogen peroxide has been removed, and the first separator and the second separator may each include at least one flow control valve.

The positions of the first separator and the second separator may vary depending on a type of organic solvent contained in the organic reaction solution.

In the extractor of the hydrogen peroxide manufacturing system according to another exemplary embodiment, the second separator is connected to the reactor through the circulation pipe so that the organic reaction solution from which the hydrogen peroxide has been removed may be introduced again into the reactor to recycle an aromatic carbonyl compound.

In the extractor of the hydrogen peroxide manufacturing system according to another exemplary embodiment, a device for separating aromatic ketone from the organic reaction solution from which the hydrogen peroxide has been removed may be further included at the rear end of the second separator.

In the hydrogen peroxide manufacturing system according to another exemplary embodiment, the purifier may include a purification tank, at least one reverse osmosis membrane of which a cross-section is located in a direction perpendicular to the flow of the hydrogen peroxide aqueous solution inside the purification tank, at least one inlet for injecting the hydrogen peroxide aqueous solution extracted from the organic reaction solution, and at least one outlet discharging the purified hydrogen peroxide aqueous solution, and a hydrogen peroxide concentration controller may be provided at the rear end of the outlet. Next, Examples and Comparative Examples of hydrogen peroxide manufacturing system and manufacturing process based on a solar reaction are illustrated.

### Example 1

### (A) Production of Hydrogen Peroxide

An organic reaction solution consisting of 30 ml of benzyl alcohol as aromatic alcohol, 29.42 ml of trifluorotoluene as an organic solvent, and 0.58 ml of water was prepared. Then, 100 mg of a polymer photocatalyst CTF-Ph was dispersed in a total of 60 ml of the organic reaction solution. Thereafter, a reaction tank was charged with oxygen gas for 30 minutes to perform an aeration process. A hydrogen peroxide generation reaction was performed by irradiating 980 W/m² of light from a solar simulator. The reaction was carried out for a maximum of 50 hours, 1 ml of a reaction sample was extracted every 3 hours and oxygen was further charged every 9 hours.

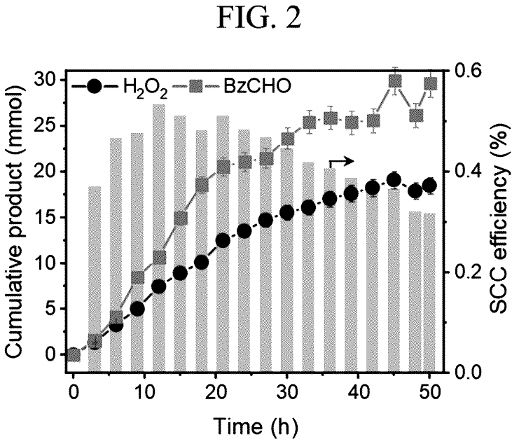

FIG. 2 illustrates production and solar-chemical conversion efficiency (SCC efficiency) of hydrogen peroxide and an oxidized organic product benzaldehyde (BzCHO) according to a 50-hour continuous process of an organic reaction solution included in the hydrogen peroxide manufacturing process and manufacturing system according to an exemplary embodiment of the present invention.

According to FIG. 2, it can be seen that the concentrations of hydrogen peroxide and an organic product obtained for 50 hours increase linearly, and it can be confirmed that 18.5 mmol of hydrogen peroxide and 29.6 mmol of a benzaldehyde organic product may be obtained. In addition, it can be seen that high concentrations of hydrogen peroxide and organic product may be stably produced in larger reaction scale and long-term experiments. When the solar-chemical conversion efficiency is derived based on the production concentration of hydrogen peroxide every 3 hours, it can be seen that high efficiency of 0.32% is maintained even after 50 hours of the reaction. Therefore, it can be seen that the hydrogen peroxide manufacturing process and manufacturing system using the organic reaction solution according to the present invention can stably produce hydrogen peroxide using light.

### (B) Extraction of Hydrogen Peroxide

The organic reaction solution containing the hydrogen peroxide obtained in the hydrogen peroxide production step was mixed with 2000 ml of water. The mixed solution was left for 1 hour until the organic reaction solution and the hydrogen peroxide aqueous solution formed an interface and were separated. The hydrogen peroxide aqueous solution formed in the upper layer of the interface was extracted.

### (C) Purification of Hydrogen Peroxide

The hydrogen peroxide aqueous solution obtained in the hydrogen peroxide extraction step was introduced into a purifier provided with a reverse osmosis membrane. At this time, a polyamide membrane (Dow Filmtec, SW30XLE) was used as the reverse osmosis membrane. The polyamide membrane was activated at a pressure of 20 bar using ultrapure water. Thereafter, reverse osmosis filtration was performed in a crossflow method, and the hydrogen peroxide aqueous solution was purified at an operating speed of 0.21 m/s. The obtained aqueous hydrogen peroxide solution was about 2 L, and the flow rate was 1.8 Lm⁻² h⁻¹ bar⁻¹.

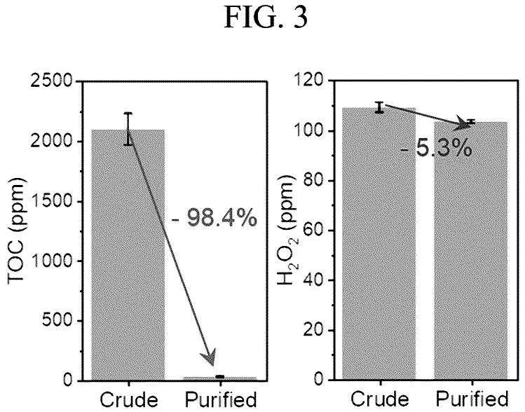

FIG. 3 illustrates purity and concentration of hydrogen peroxide prepared according to an exemplary embodiment of the present invention.

In addition, according to FIG. 3, the concentration of hydrogen peroxide in the obtained hydrogen peroxide aqueous solution was 103.4 ppm, and the concentration of total organic carbon (TOC) contained in the aqueous solution was 32.7 ppm, which showed the purity of 99.997%.

The following is Experimental Example of confirming water treatment performance of hydrogen peroxide prepared according to Example of the present invention.

### (Experimental Example 1) Confirmation of Water Treatment Performance of Hydrogen Peroxide Prepared by the Present Invention

Hydrogen peroxide is a material used as an oxidizing agent to degrade organic pollutants in a water purification process. An organic water treatment mechanism using hydrogen peroxide is characterized by degrading organic materials using the oxidizing power of OH radicals generated by activating hydrogen peroxide. In order to confirm the usability of hydrogen peroxide finally produced according to an exemplary embodiment of the present invention, its performance was confirmed by applying the hydrogen peroxide to a water treatment reaction.

In a typical water treatment reaction, a Fenton oxidation method is used to activate hydrogen peroxide. The Fenton oxidation is a method of injecting ferrous ions together with hydrogen peroxide to activate hydrogen peroxide into OH radicals through oxidation of iron ions.

After iron ions (3 mM) and the produced hydrogen peroxide (3 mM) were added to methylene blue (50 ppm, pH 3), an organic pollutant, the degradation behavior of the pollutant was observed through color change.

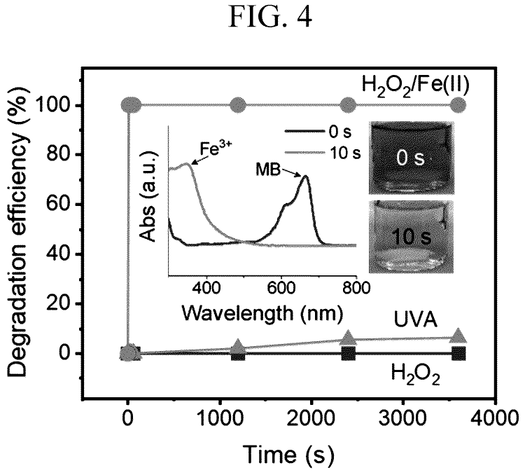

FIG. 4 illustrates water treatment performance for organic pollutants of high-concentration and high-purity hydrogen peroxide prepared according to an exemplary embodiment of the present invention.

According to FIG. 4, it can be seen that organic pollutants are completely degraded only in 10 seconds by a high concentration of hydrogen peroxide to be changed colorless. On the other hand, when organic pollutants of the same concentration are treated with hydrogen peroxide or UV light alone, there is no change in concentration. The results prove that the pollutants were degraded through activation of hydrogen peroxide. Therefore, it can be confirmed that the high-concentration and high-purity of hydrogen peroxide obtained from the continuous hydrogen peroxide manufacturing system and manufacturing process based on the solar reaction of the present invention can be used in practical applications such as water purification.

What is claimed is:

1. A hydrogen peroxide manufacturing process based on a photochemical reaction comprising:
a production step of generating hydrogen peroxide by supplying oxygen and irradiating light to an organic reaction solution;
an extraction step of separating the hydrogen peroxide into an aqueous solution by mixing the organic reaction solution in which the hydrogen peroxide is generated and water; and
a purification step of filtering the extracted hydrogen peroxide aqueous solution using a reverse osmosis membrane,
wherein the organic reaction solution includes a hydrophobic organic solvent in the range of 50 volume % or more based on the total volume of the organic reaction solution.

2. The hydrogen peroxide manufacturing process based on the photochemical reaction of claim 1, wherein:
in the production step, the organic reaction solution is a mixture of aromatic alcohol and an organic solvent, and
the aromatic alcohol includes 0.1 wt % to 0.2 wt % of an aromatic carbonyl compound based on the total weight of the aromatic alcohol.

3. The hydrogen peroxide manufacturing process based on the photochemical reaction of claim 1, wherein:
the production step comprises further mixing the aromatic carbonyl compound with the organic reaction solution.

4. The hydrogen peroxide manufacturing process based on the photochemical reaction of claim 3, wherein:
the further mixed aromatic carbonyl compound is at least one selected from aromatic ketones or aromatic aldehydes.

5. The hydrogen peroxide manufacturing process based on the photochemical reaction of claim 4, wherein:
the aromatic ketone or aromatic aldehyde is at least one selected from benzaldehyde (BzCHO), 9-anthracenecarboxaldehyde, 9-anthraldehyde, 9-phenanthrenecarboxaldehyde, fluorene-2-carboxaldehyde, 1-pyrenecarboxaldehyde, 1-naphthaldehyde, 2-naphthaldehyde, biphenyl-4-carboxaldehyde, benzophenone, 4-methylbenzaldehyde (p-tolualdehyde), 3-methylbenzaldehyde (m-tolualdehyde), 2-methylbenzaldehyde (o-tolualdehyde), 4-chlorobenzaldehyde, 3-chlorobenzaldehyde, 2-chlorobenzaldehyde, 4-fluorobenzaldehyde, 3-fluorobenzaldehyde, 2-fluorobenzaldehyde, 4-bromobenzaldehyde, 3-bromobenzaldehyde, 2-bromobenzaldehyde, 1-(p-tolyl) ethanone, 1-(4-fluorophenyl) ethanone, p-anisaldehyde, 4-formylbenzonitrile, 4-methoxyacetophenone, 4-acetylbenzonitrile, anthraquinone, fluorenone, acetophenone, xanthone, and thioxanthone.

6. The hydrogen peroxide manufacturing process based on the photochemical reaction of claim 3, wherein:
based on the total volume of the mixture of the aromatic alcohol, the organic solvent, and the further mixed aromatic carbonyl compound, the aromatic carbonyl compound is further mixed and included in the range of 0.001 volume % to 30 volume %.

7. The hydrogen peroxide manufacturing process based on the photochemical reaction of claim 2, wherein:
the aromatic alcohol is at least one selected from the group consisting of benzyl alcohols substituted with electron-withdrawing and electron-donating functional groups.

8. The hydrogen peroxide manufacturing process based on the photochemical reaction of claim 7, wherein:
the group consisting of benzyl alcohols substituted with electron-withdrawing and electron-donating functional groups includes benzyl alcohol (BzOH), 4-fluorobenzyl alcohol (F-BzOH), 3-fluorobenzyl alcohol, 2-fluorobenzyl alcohol, 4-methylbenzyl alcohol (M-BzOH), 3-methylbenzyl alcohol, 2-methylbenzyl alcohol, α-methylbenzyl alcohol (α-M-BzOH), diphenylmethanol (DPM), and cinnamyl alcohol.

9. The hydrogen peroxide manufacturing process based on the photochemical reaction of claim 2, wherein:
the aromatic alcohol is mixed and included in a volume ratio of 1:99 to 99:1 based on the volume of the organic solvent mixed in the organic reaction solution.

10. The hydrogen peroxide manufacturing process based on the photochemical reaction of claim 2, wherein:
the solubility of oxygen in the organic solvent is 1 mM to 15 mM based on 1 atm.

11. The hydrogen peroxide manufacturing process based on the photochemical reaction of claim 2, wherein:
the organic solvent includes a hydrophobic organic solvent, and
the hydrophobic organic solvent has an octanol-water partition coefficient (log P) value represented by the following Equation 1 of 0 or more:
Octanol-water partition coefficient=log P=log([C_{oct}]/[C_{water}]) [Equation 1]
(wherein, [C_{oct}] refers to a molar concentration of the organic solvent dissolved in the octanol layer, and [C_{water}] refers to a molar concentration of the organic solvent dissolved in the water layer.)

12. The hydrogen peroxide manufacturing process based on the photochemical reaction of claim 2, wherein:
the organic solvent is at least one selected from trifluorotoluene, acetonitrile, methanol, ethanol, tert-butanol, 1-propanol, 2-propanol, acetone, ethyl acetate, tert-amyl alcohol, 1-butanol, petroleum ether, pentane, cyclohexane, n-hexane, dichloromethane, chloroform, tetrahydrofuran, 1,4-dioxane, toluene, dimethyl sulfoxide (DMSO), dimethylformamide, 1,2-dichloroethane, 1-octanol, benzonitrile, butanone, cyclohexanone, methyl tert-butyl ether, 2-hexanone, butyl acetate, trichloroethylene, xylene, and ethyl benzene.

13. The hydrogen peroxide manufacturing process based on the photochemical reaction of claim 1, wherein:
in the production step, the oxygen supply rate is in the range of 10 mL/min to 50 mL/min.

14. The hydrogen peroxide manufacturing process based on the photochemical reaction of claim 1, wherein:
in the production step, the oxygen supply time is in the range of 15 min to 60 min.

15. The hydrogen peroxide manufacturing process based on the photochemical reaction of claim 1, wherein:
in the production step, the irradiated light wavelength includes a bandwidth of 200 nm to 500 nm.

16. The hydrogen peroxide manufacturing process based on the photochemical reaction of claim 1, wherein:
in the production step, the light irradiation time is in the range of more than 0 and 60 hours or less.

17. The hydrogen peroxide manufacturing process based on the photochemical reaction of claim 1, wherein:
the production step comprises irradiating light with an irradiance of 10 W/m² to 1000 W/m².

18. The hydrogen peroxide manufacturing process based on the photochemical reaction of claim 1, wherein:
the production step comprises further mixing a polymer photocatalyst and water with the organic reaction solution,
wherein the polymer photocatalyst includes at least one selected from CTF-Ph, CTF-Th, CTF-BPh, and graphitic carbon nitride (g-C₃N₄).

19. The hydrogen peroxide manufacturing process based on the photochemical reaction of claim 18, wherein:
in the production step, the concentration of the polymer photocatalyst further mixed with the organic reaction solution is in the range of 0.1 g/L to 4.0 g/L.

20. The hydrogen peroxide manufacturing process based on the photochemical reaction of claim 18, wherein:
the water is included in the range of 0 to 30 mol % based on the total amount of aromatic alcohol contained in the organic reaction solution.

21. The hydrogen peroxide manufacturing process based on the photochemical reaction of claim 1, wherein:
the volume ratio of the water mixed in the extraction step and the organic reaction solution in which hydrogen peroxide is generated is 0.1 to 10.

22. The hydrogen peroxide manufacturing process based on the photochemical reaction of claim 1, wherein:
the extraction step further comprises a process of mixing and then stirring the organic reaction solution in which the hydrogen peroxide is generated and water for extraction,
wherein the stirring speed is 100 rpm to 1000 rpm.

23. The hydrogen peroxide manufacturing process based on the photochemical reaction of claim 1, wherein:
in the extraction step, the time for which the solution mixed with the organic reaction solution in which hydrogen peroxide is generated and the water for extraction remains inside the extractor is 1 minute to 180 minutes.

24. The hydrogen peroxide manufacturing process based on the photochemical reaction of claim 1, wherein:
the extraction step comprises separating and then discharging a hydrogen peroxide aqueous solution layer and an organic solution layer, respectively, and
a method of discharging the aqueous solution layer and the organic solution layer is an intermittent method.

25. The hydrogen peroxide manufacturing process based on the photochemical reaction of claim 24, wherein:
the discharge rate of the aqueous solution layer is 0.1 L/h to 20 L/h, and
the discharge rate of the organic solution layer is 0.1 L/h to 20 L/h.

26. The hydrogen peroxide manufacturing process based on the photochemical reaction of claim 1, wherein:
in the purification step, a reverse osmosis filtration is operated in a crossflow manner,
based on a reverse osmosis membrane with an effective area of 20 cm², the reverse osmosis filtration speed is 0.05 m/s to 1.0 m/s, and
the reverse osmosis membrane is a polyamide reverse osmosis membrane and has a maximum operating pressure of 80 bar.

27. The hydrogen peroxide manufacturing process based on the photochemical reaction of claim 1, wherein:
the mass ratio of total organic carbon (TOC) contained in the hydrogen peroxide aqueous solution finally obtained through the hydrogen peroxide manufacturing process of claim 1 is 0.01% to 1% based on the total mass of the hydrogen peroxide aqueous solution.

28. The hydrogen peroxide manufacturing process based on the photochemical reaction of claim 1, further comprising:
after the production step, a catalyst regeneration step in which the polymer photocatalyst is separated from the organic reaction solution containing hydrogen peroxide discharged from the reactor, supplied in circulation to the reactor, and
the organic reaction solution containing hydrogen peroxide from which the catalyst is separated is supplied to the extractor.

29. A hydrogen peroxide manufacturing system based on a photochemical reaction comprising:
a reactor capable of producing hydrogen peroxide through a photoautoxidation reaction using an organic reaction solution;
an extractor that extracts the hydrogen peroxide produced in the reactor into an aqueous solution using a large amount of water; and
a purifier for separating and purifying the hydrogen peroxide in the aqueous solution,
wherein the reactor, the extractor, and the purifier are sequentially connected to each other,
a catalyst regenerator is located between the reactor and the extractor and connected to the reactor through a circulation pipe,
a mixer is located between the extractor and the catalyst regenerator to mix the organic reaction solution from which the polymer photocatalyst is separated and water for extraction, and
a stirrer is further included in the mixer.

30. The hydrogen peroxide manufacturing system based on the photochemical reaction of claim 29, wherein: the reactor comprises
a reaction tank having at least one reaction solution outlet at the bottom;
an inlet capable of injecting an organic reaction solution and oxygen into the reaction tank;
an irradiator capable of transmitting light while sealing the reaction tank; and
a light source.

31. The hydrogen peroxide manufacturing system based on the photochemical reaction of claim 29, wherein: the extractor comprises
an inlet;
a first separator for extracting the hydrogen peroxide aqueous solution; and
a second separator for discharging the organic reaction solution from which the hydrogen peroxide has been removed,
wherein the first separator and the second separator each includes at least one flow control valve.

32. The hydrogen peroxide manufacturing system based on the photochemical reaction of claim 31, wherein:
the second separator is connected to the reactor through a circulation pipe so that the organic reaction solution from which the hydrogen peroxide has been removed is introduced again into the reactor to recycle an aromatic carbonyl compound.

33. The hydrogen peroxide manufacturing system based on the photochemical reaction of claim 31, further comprising:
a device for separating aromatic ketone from the organic reaction solution from which the hydrogen peroxide has been removed at the rear end of the second separator.

34. The hydrogen peroxide manufacturing system based on the photochemical reaction of claim 29, wherein: the purifier comprises
a purification tank;
at least one reverse osmosis membrane of which a cross-section is located in a direction perpendicular to the flow of the hydrogen peroxide aqueous solution inside the purification tank;
at least one inlet for injecting the hydrogen peroxide aqueous solution extracted from the organic reaction solution; and
at least one outlet for discharging the purified hydrogen peroxide aqueous solution,
wherein a hydrogen peroxide concentration controller is provided at the rear end of the outlet.
